(19) United States
(12) Patent Application Publication
(10) Pub. No.: US 2026/0336010 A1
(43) Pub. Date: Oct. 29, 2026

(54) Portable Handheld Welding Machine Powered by Miniature Lithium Batteries

(71) Applicant: Jian Qian, Yongkang (CN)

(72) Inventor: Jian Qian, Yongkang (CN)

(21) Appl. No.: 19/189,642

(22) Filed: Apr. 25, 2025

(51) Int. Cl. B23K 9/10

(52) U.S. Cl. CPC B23K 9/1006

(57) ABSTRACT

The present invention discloses a portable handheld welding machine powered by a miniature lithium battery, comprising a housing and a handle integrally formed with the housing. The housing is fixed by two half shells through bolts, with a welding rod on one side, a welding mechanism inside the body, a protective mechanism on one side, and a processing mechanism at the tail; The welding mechanism includes a battery pack, and one side of the outer wall of the shell is provided with an installation groove. The inner wall of the installation groove is provided with a hemispherical groove. Elastic sheets are fixed on both sides of the battery pack. The present invention can perform welding operations through the set press switch, which can avoid repeated insertion operations by workers, reduce their labor intensity, and achieve the effect of low safety hazards in the working area.

### TECHNICAL FIELD

The present invention relates to the field of handheld welding machine technology, specifically a portable handheld welding machine powered by miniature lithium batteries.

### BACKGROUND OF THE PRESENT INVENTION

An electric welding machine uses the high-temperature arc generated by the instantaneous short circuit between the positive and negative poles to melt the solder on the welding electrode and the material to be welded, in order to bond the objects in contact, its structure is very simple, just a high-power transformer, the electric welding machines are usually used in industry and also need to be used for auxiliary work in screen processing.

At present, the Chinese patent with the announcement number CN218891303U discloses an electric welding machine body and a protective base, the middle of the top of the protective base is provided with an installation groove, and the middle of the installation groove is connected to the electric welding machine body, the top of one side of the electric welding machine body is hinged with a hinge column, and the bottom end of the hinge column is fixedly connected to a second installation plate, this utility model electric welding machine, by setting a protective base, is convenient to increase the bottom protection structure of the electric welding machine body, effectively preventing the wear of the bottom end of the electric welding machine body and shortening the service life of the electric welding machine body, the user places the electric welding machine body on the protective base, and the electric welding machine body is not in direct contact with the ground, effectively protecting the electric welding machine body, the install plates and support rods to effectively increase the ventilation function of the welding machine body, The ventilation of the welding machine body is more convenient, which will not cause damage to the electronic components in the welding machine body and is more convenient to use.

However, when using the above device, users need to connect external wires, when the socket and work area are far apart, longer wires need to be used, once the wires become loose, workers need to return to the socket for re plugging, which increases the labor intensity of workers, at the same time, the longer wires are laid, which increases the safety hazards in the work area.

Therefore, the present invention provides a portable handheld welding machine powered by miniature lithium batteries.

### SUMMARY OF PRESENT INVENTION

In response to the shortcomings of existing technology, the present invention provides a portable handheld welding machine powered by miniature lithium batteries to solve the above-mentioned problems.

To achieve the above objectives, the present invention is implemented through the following technical solutions: a portable handheld welding machine powered by a miniature lithium battery, comprising a housing and a grip integrally formed with the housing, the housing is fixed by two half shells through bolts, one side of the housing is provided with a welding rod, a welding mechanism is provided inside the housing, one side of the housing is provided with a protective mechanism, and the tail of the housing is provided with a processing mechanism;

The welding mechanism comprises a battery pack, one side of the outer wall of the shell is provided with an installation groove, and both sides of the inner wall of the installation groove are provided with grooves in a hemispherical structure, the elastic sheets are fixedly connected to both sides of the battery pack, and the elastic sheets form a sliding fit with the inner wall of the installation groove, the tail of the elastic sheets is fixedly connected with an integrated protrusion, which is in a hemispherical structure and forms a sliding fit with the inner wall of the groove, a switch is fixedly connected to the connection between the handle and the shell, the welding rod and the switch are both connected to the battery pack through wires, by pressing the switch, the welding rod can be powered on and welded, the welding rod is fixed by Connect the component to the shell.

As the preferred technical solution of the present invention, the fixing component comprises a fixing ring, and one side of the housing is fixed to the fixing ring, one side of the outer wall of the fixing ring is provided with a threaded hole, and the inner wall of the threaded hole is connected to a threaded rod through threads, one side of the threaded rod is fixedly connected to a rotating block, which is far away from the welding rod.

As the preferred technical solution of the present invention, the protective mechanism comprises two symmetrically distributed fixed plates, which are fixed to the inner wall of the fixed ring, one side of the fixed plate is rotatably connected to a fixed shaft through a bearing, and one side of the fixed shaft is fixedly connected to a force plate, the side of the fixed shaft away from the force plate is fixedly connected to a force plate, and one side of the force plate is fixedly connected to a top block, which has a spherical structure, the top block is in contact with the welding rod, and the force plate has a V-shaped structure, the welding rod can be locked by the force plate.

As the preferred technical solution of the present invention, the threaded rod is fixedly connected to a pressure plate with a circular arc structure on the side away from the rotating block, one side of the pressure plate is fixedly connected to a pressure block, and one side of the pressure block is provided with a pressure groove, the top and bottom of the pressure plate are both provided with rotating grooves, and the inner wall of the rotating groove is rotatably connected to a rotating shaft through a bearing, the rotating shaft forms a rolling fit with the force plate.

As the preferred technical solution of the present invention, the processing mechanism comprises a fan located at the rear of the housing, and the exhaust end of the fan is fixedly connected to a processing box, one side of the outer wall of the processing box is provided with an air outlet, and the outer wall of the processing box on the side away from the air outlet is provided with a vent, the inner wall of the air outlet covers the exhaust end of the fan, and a filter screen plate is installed inside the processing box.

As the preferred technical solution of the present invention, a dust removal mesh plate is installed inside the processing box, and one side of the dust removal mesh plate is provided with a limited position port, the dust removal mesh plate is located between the filter mesh plate and the air outlet, and the air outlet is fixedly connected to an air duct, the cross-section of the air duct near the air outlet is trapezoidal, and one end of the air duct near the dust removal mesh plate forms a sliding fit with the inner wall of the limited position port.

As the preferred technical solution of the present invention, the top and bottom inner walls of the processing box are both provided with T-shaped connection grooves, the inner walls of the connection grooves are slidably connected to T-shaped connection blocks, and one side of the connection block is fixedly connected to a connection spring, the connection spring is fixed to one side of the inner wall of the connection groove, and the connection blocks are respectively fixed to the filter screen plate and the dust removal screen plate.

As the preferred technical solution of the present invention, the top and bottom inner walls of the processing box are both connected to a rotating shaft through bearings, and the surface of the rotating shaft is fixedly connected to a cam, which is in contact with the filter plate and the dust removal plate, respectively.

As the preferred technical solution of the present invention, the driving shaft of the fan is fixedly connected with a positioning shaft, which passes through the air duct, one side of the positioning shaft is fixedly connected with a worm, and the surface of the rotating shaft is fixedly connected with a worm wheel, which meshes with the worm.

As the preferred technical solution of the present invention, one side of the outer wall of the processing box is provided with a processing port, and one side of the outer wall of the processing box is hinged with a processing door covering the processing port, the processing door is fixed to the processing box through a lock buckle, and is located between the filter screen plate and the dust removal screen plate.

As the preferred technical solution of the present invention, one side of the welding rod is fixedly connected to a support, which is located inside a fixed ring, the surface of the support is connected to a threaded ring through threads, and a gasket is placed on the side of the threaded ring near the welding rod, one side of the support is provided with a wiring channel.

### BENEFICIAL EFFECTS

Compared with the prior art, the present invention has the following beneficial effects:
(1) This miniature lithium battery powered portable handheld welding machine can be prepared for handheld spot welding by inserting the set battery pack into the installation groove and inserting it into the groove with the protrusion on the elastic sheet, when welding, the welding rod is fixed to increase the stability of the welding operation. When the welding rod is installed, the switch can be pressed to perform the welding operation, which means that the worker can directly carry out the operation by hand, therefore, it can avoid the worker returning to the socket for re plugging operation, reduce the labor intensity of the worker, and achieve the effect of low safety hazards in the work area.
(2) This miniature lithium battery powered portable handheld welding machine can apply force to the force plate through the movement of the pressure plate, the force plate, when matched with a fixed shaft, can rotate and fix the top block of the force plate to the surface of the welding rod, when matched with the pressure block, the welding rod can be fixed at three points, which can prevent the welding rod from falling off and increase the stability of the welding operation.
(3) The miniature lithium battery powered portable handheld welding machine can generate smoke and dust during welding by rotating the fan blades, the smoke and dust generated during welding can be sucked into the processing box through the hollow surface of the shell, as the smoke and dust are sucked into the space between the dust removal screen plate and the filter screen plate through the air duct, they can be located between the filter screen plate and the dust removal screen plate, which can prevent the fan from flowing back into the shell after it stops working, the air duct can greatly reduce the exhaust end area of the fan.
(4) The miniature lithium battery powered portable handheld welding machine can rotate the worm through the set positioning shaft, which can rotate the worm gear, the rotation of the worm gear can rotate the worm wheel, which can rotate the rotating shaft, the rotation of the rotating shaft can rotate the cam, which can strike and clean the dust on the surface of the dust removal and filter plates, ensuring the airflow permeability of the dust removal and filter plates.
(5) The miniature lithium battery powered portable handheld welding machine, through the movement of the set connection block in the connection groove and the elastic force reset operation of the connection spring, can make the dust removal screen plate and the filter screen plate exhibit reciprocating motion, which can make the dust removal screen plate and the filter screen plate exhibit intermittent motion, the shaking of the dust removal screen plate and the filter screen plate can avoid the accumulation of smoke and dust in the fixed position inside the processing box, so as to avoid the adhesion of smoke and dust inside the processing box, and facilitate the subsequent cleaning operation of smoke and dust by the staff.

### BRIEF DESCRIPTION OF THE DRAWINGS

FIG. 1 is a schematic diagram of the three-dimensional structure of the present invention;

FIG. 2 is a schematic diagram of the protruding structure of the present invention;

FIG. 3 is a schematic diagram of the force application plate structure of the present invention;

FIG. 4 is a schematic diagram of the rotating shaft structure of the present invention;

FIG. 5 is a schematic diagram of the processing gate structure of the present invention;

FIG. 6 is a schematic diagram of the structure of the air duct of the present invention;

FIG. 7 is an enlarged schematic diagram of the structure at point A in FIG. 6;

FIG. 8 is a schematic diagram of the worm gear structure of the present invention.

1. Housing; 2. Handle; 3. Battery pack; 4. Installation groove; 5. Elastic sheet; 6. Protrusion; 7. Groove; 8. Switch; 9. Welding rod; 10. Fixed ring; 11. Threaded hole; 12. Threaded rod; 13. Rotating block; 14. Fixed plate; 15. Fixed axis; 16. Force plate; 17. Force plate; 18. Top block; 19. Pressure plate; 20. Rotating grooves; 21. Rotation axis; 22. Fan; 23. Processing box; 24. Wind outlet; 25. Filter screen plate; 26. Port; 27. Dust removal mesh plate; 28. Limit port; 29. Rotating shaft; 30. Cam; 31. Worm gear; 32. Worm gear; 33. Positioning shaft; 34. Connection groove; 35. Connection block; 36. Connecting springs; 37. Processing door; 38. Processing port; 39. Air duct. 40. Support; 41. Threaded ring; 42. Gasket; 43. Wiring channel.

### DETAILED DESCRIPTION OF THE EMBODIMENT'S

Below, the technical solutions in the embodiments of the present invention will be clearly and completely described in conjunction with the accompanying drawings, obviously, the described embodiments are only a part of the embodiments of the present invention, not all of them, based on the embodiments of the present invention, all other embodiments obtained by ordinary skilled persons in the art without creative labor are within the scope of protection of the present invention.

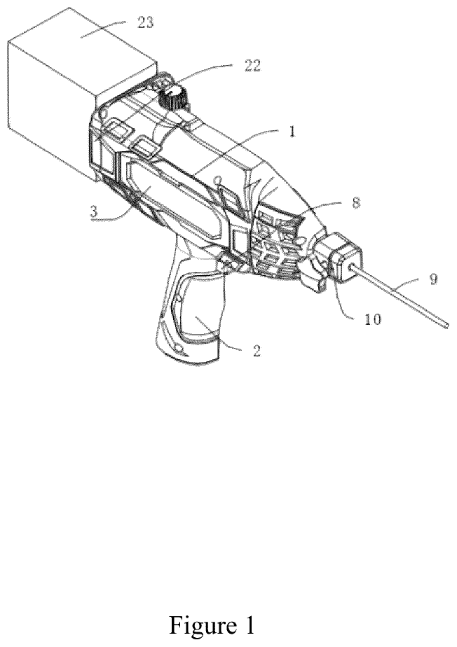

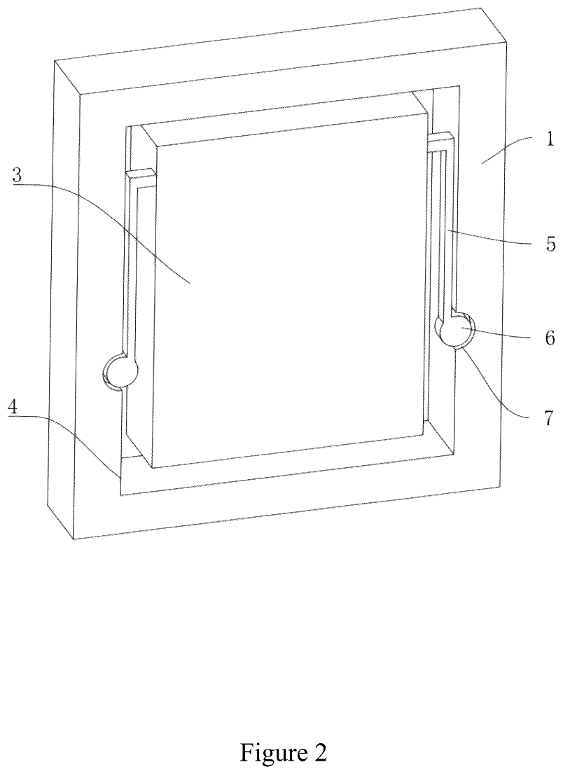

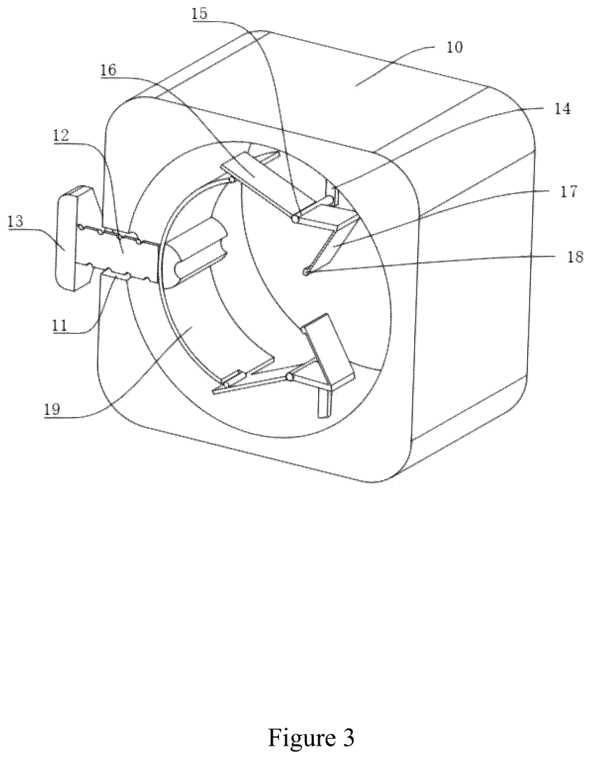

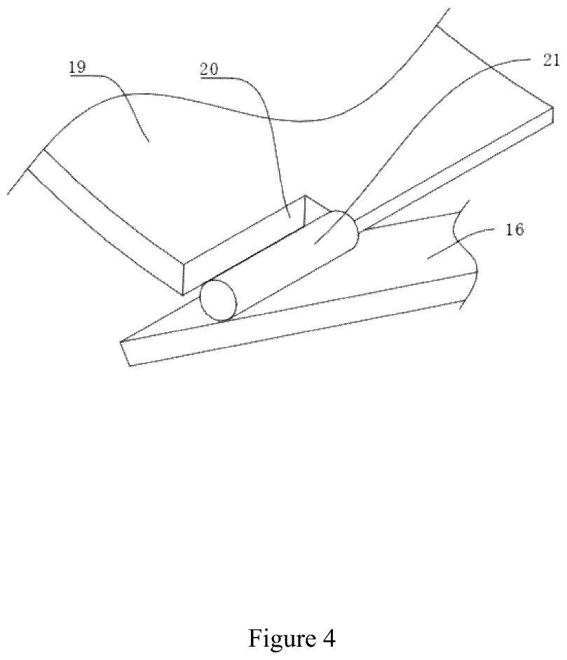

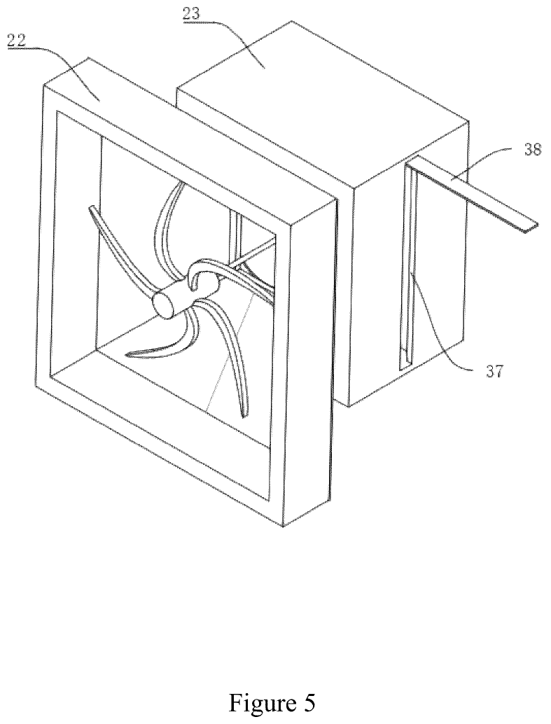

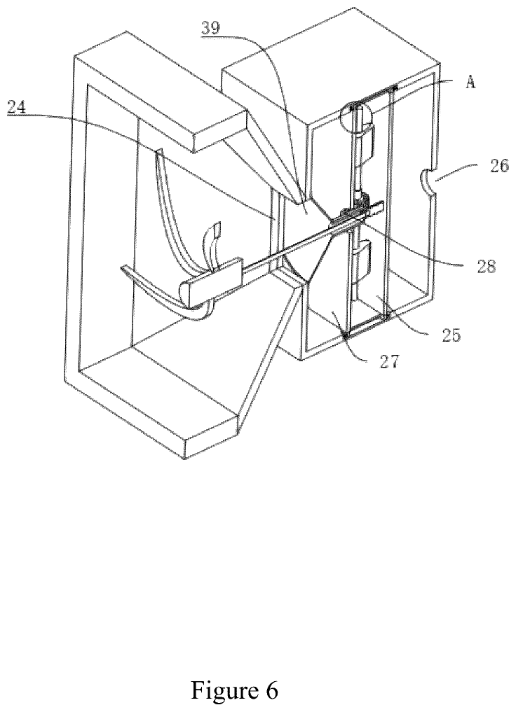

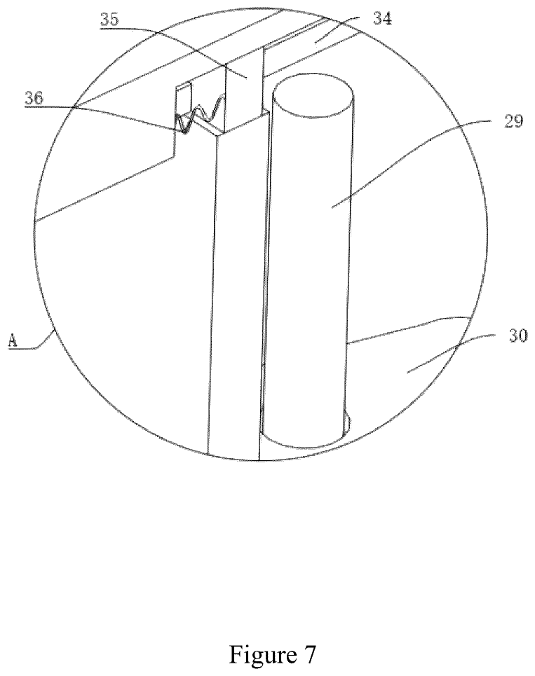

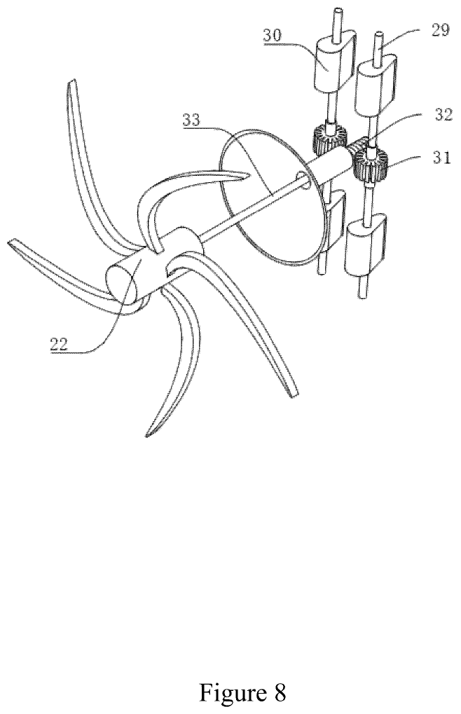

Please refer to FIG. 1-8, a portable handheld welding machine powered by micro lithium batteries, comprising a housing 1 and a handle 2 integrally formed with the housing 1, the housing 1 is fixed by two half shells through bolts, with a welding rod 9 on one side of the housing 1, a welding mechanism inside the housing 1, a protective mechanism on one side of the housing 1, and a processing mechanism at the tail of the housing 1;

The welding mechanism includes a battery pack 3, one side of the outer wall of the shell 1 is provided with an installation groove 4, and both sides of the inner wall of the installation groove 4 are provided with grooves 7 in a hemispherical structure, the elastic sheets 5 are fixedly connected to both sides of the battery pack 3, and the elastic sheets 5 form a sliding fit with the inner wall of the installation groove 4, the tail of the elastic sheet 5 is fixedly connected to an integrated protrusion 6, which is in a hemispherical structure, the protrusion 6 forms a sliding fit with the inner wall of the groove 7, a switch 8 is fixedly connected to the connection between the handle 2 and the housing 1, the welding rod 9 and the switch 8 are both connected to the battery pack 3 through wires, by pressing the switch 8, the welding rod 9 can be energized and welded, the welding rod 9 is fixed to the housing 1 through a fixing piece, connect and insert the set battery pack 3 into the installation groove 4, after inserting the protrusion 6 on the elastic sheet 5 into the groove 7, The preparation work for handheld spot welding can be completed by fixing the welding rod 9 during the welding operation, which can increase the operational stability of the welding operation, when the welding rod 9 is installed, the switch 8 can be pressed to perform the welding operation, which means that the worker can directly carry out the operation by hand, therefore, it can avoid the worker returning to the socket for re plugging operation, reduce the labor intensity of the worker, and achieve the effect of low safety hazards in the work area.

As a further improvement of the present invention, the fixing component comprises a fixing ring 10, with one side of the housing 1 fixed to the fixing ring 10, one side of the fixing ring 10 has a threaded hole 11 on its outer wall, and the inner wall of the threaded hole 11 is connected to a threaded rod 12 through threads, one side of the threaded rod 12 is fixedly connected to a rotating block 13, which is away from the welding rod 9, the rotation of the rotating block 13 can rotate the threaded rod 12, and the rotation of the threaded rod 12 in the threaded hole 11 can move the threaded rod 12 in the threaded hole 11, allowing the pressure plate 19 to move and the pressure block to clamp and fix the welding rod 9.

As a further improvement of the present invention, the protective mechanism comprises two symmetrically distributed fixed plates 14, which are fixed to the inner wall of the fixed ring 10, one side of the fixed plate 14 is rotatably connected to a fixed axis 15 through a bearing, and one side of the fixed axis 15 is fixedly connected to a force plate 16, the side of the fixed axis 15 away from the force plate 16 is fixedly connected to a force plate 17, and one side of the force plate 17 is fixedly connected to a top block 18, the top block 18 has a spherical structure, and the top block 18 is in contact with the welding rod 9, the force plate 17 has a V-shaped structure, the welding rod 9 can be locked by the force plate 17, and the force plate 17 can be locked by cooperating with the fixed shaft 15 through the set force plate 16, by rotating the operation, the top block of the force plate 17 can be fixed to the surface of the welding rod 9, which can prevent the welding rod 9 from falling off.

As a further improvement of the present invention, the threaded rod 12 is fixedly connected to a pressure plate 19 with a circular arc structure on the side away from the rotating block 13, one side of the pressure plate 19 is fixedly connected to a pressure block, and one side of the pressure block is provided with a pressure groove, the top and bottom of the pressure plate 19 are both provided with rotation grooves 20, the inner wall of the rotation groove 20 is rotatably connected to a rotation axis 21 through a bearing, the rotation axis 21 forms a rolling fit with the force plate 16, by moving the pressure plate 19, the pressure plate 19 can apply force to the force plate 16, and the force plate 16, in conjunction with the fixed axis 15, can rotate the force plate 17, at this time, the top block of the force plate 17 can be fixed to the surface of the welding rod 9, and the fit is achieved, the pressure block can perform three-point fixing operation on the welding rod 9, which can fix the welding rod 9 and prevent it from falling off, Can increase the operational stability during welding operations.

As a further improvement of the present invention, the processing mechanism comprises a fan 22 located at the rear of the housing 1, the exhaust end of the fan 22 is fixedly connected to a processing box 23, and one side of the outer wall of the processing box 23 is provided with a wind outlet 24, the outer wall of the side of the processing box 23 away from the wind outlet 24 is provided with a through port 26, and the inner wall of the wind outlet 24 covers the exhaust end of the fan 22, a filter screen plate 25 is provided inside the processing box 23, and a dust removal screen plate 27 is provided inside the processing box 23, one side of the dust removal screen plate 27 is provided with a limited position port 28, and the dust removal screen plate 27 is located between the filter screen plate 25 and the wind outlet 24, the inner wall of the wind outlet 24 is fixedly connected to an air duct 39, and the cross section of the side of the air duct 39 One end of the dust removal mesh plate 27 forms a sliding fit with the inner wall of the limit port 28, By rotating the fan blades of the set fan 22, the smoke generated during welding can be sucked into the processing box 23 through the hollow surface of the shell 1, as the smoke is sucked into the space between the dust removal screen plate 27 and the filter screen plate 25 through the air duct 39, it can be located between the filter screen plate 25 and the dust removal screen plate 27, which can prevent the smoke from flowing back into the shell 1 through the fan 22 after the fan 22 stops working, the air duct 39 can greatly reduce the exhaust end area of the fan 22.

As a further improvement of the present invention, the top and bottom inner walls of the processing box 23 are both provided with T-shaped connection grooves 34, the inner wall of the connection groove 34 is slidably connected to a T-shaped connection block 35, and one side of the connection block 35 is fixedly connected to a connection spring 36, the connection spring 36 is fixed to one side of the inner wall of the connection groove 34, and the connection block 35 is respectively fixed to the filter screen plate 25 and the dust removal screen plate 27, through the movement of the set connection block 35 in the connection groove 34 and the elastic force reset operation of the connection spring 36, the dust removal screen plate 27 and the filter screen plate 25 can be made to move back and forth, and the dust removal screen plate 27 and the filter screen plate 25 can be made to move intermittently, so as to facilitate the subsequent operation of the staff, clean up the smoke and dust.

As a further improvement of the present invention, the top and bottom inner walls of the processing box 23 are both connected to a rotating shaft 29 through bearings, and a cam 30 is fixedly connected to the surface of the rotating shaft 29, the cam 30 is in contact with the filter plate 25 and the dust removal plate 27, respectively, by rotating the cam 30, the dust removal plate 27 and the filter plate 25 can be knocked, which can clean the dust on the surfaces of the dust removal plate 27 and the filter plate 25 and ensure the airflow permeability of the dust removal plate 27 and the filter plate 25.

As a further improvement of the present invention, the driving shaft of the fan 22 is fixedly connected to a positioning shaft 33, which passes through the air duct 39, one side of the positioning shaft 33 is fixedly connected to a worm 32, and the surface of the rotating shaft 29 is fixedly connected to a worm wheel 31, which meshes with the worm 32, a processing port 38 is opened on one side of the outer wall of the processing box 23, and a processing door 37 covering the processing port 38 is hinged on one side of the outer wall of the processing box 23, the processing door 37 is fixed to the processing box 23 through a lock buckle, the processing door 37 is located between the filter screen plate 25 and the dust removal screen plate 27, the rotation of the positioning shaft 33 can cause the worm 32 to rotate, and the rotation of the worm wheel 32 can cause the worm wheel 31 to rotate, at this time, the cam 30 can rotate, the process door 37 to allow smoke and dust to be discharged through processing port 38.

As a further improvement of the present invention, one side of the welding rod 9 is fixedly connected to a support 40, which is located inside the fixed ring 10, the surface of the support 40 is connected to a threaded ring 41 through threads, and a gasket 42 is placed on the side of the threaded ring 41 near the welding rod 9, a wiring channel 43 is provided on one side of the support 40.

Meanwhile, any content not described in detail in this manual belongs to the existing technology known to those skilled in the art.

Working principle of the present invention: When in use, the battery pack 3 is inserted into the installation groove 4, with the protrusion 6 on the elastic plate 5 inserted into the groove 7, the preparation work for handheld spot welding can be completed, during the welding operation, the welding rod 9 is inserted into the fixed ring 10, at this time, the rotating block 13 can be rotated, and the rotation of the rotating block 13 can cause the threaded rod 12 to rotate, the rotation of the threaded rod 12 in the threaded hole 11 can cause the threaded rod 12 to move in the threaded hole 11, and the pressure plate 19 can be moved to clamp and fix the welding rod 9, with the movement of the pressure plate 19, the pressure plate 19 can apply force to the force plate 16, and the force plate 16 cooperates with it, the fixed axis 15 can enable the rotating operation of the force plate 17, which can fix the top block of the force plate 17 to the surface of the welding rod 9, By cooperating with the pressure block, the welding rod 9 can be fixed at three points, which can prevent the welding rod 9 from falling off and increase the stability of the welding operation, when the welding rod 9 is installed, the switch 8 can be pressed to enable the battery pack 3 to power on the welding and fan 22, and the welding operation can be carried out directly by hand, therefore, it can avoid the worker from returning to the socket for re plugging operation, reduce the labor intensity of the worker, and achieve the effect of low safety hazards in the work area;

When the fan 22 is powered on, it will rotate, the rotation of the fan blades of the fan 22 can cause the smoke generated during welding to be sucked into the processing box 23 through the hollow surface of the housing 1, as the smoke is sucked into the space between the dust removal screen plate 27 and the filter screen plate 25 through the air duct 39, it can be located between the filter screen plate 25 and the dust removal screen plate 27, which can prevent the smoke from flowing back into the shell 1 through the fan 22 after the fan 22 stops working, the a ir duct 39 can greatly reduce the exhaust end area of the fan 22;

When the fan blades of fan 22 are rotated, the driving shaft of fan 22 can cause the positioning shaft 33 to rotate, which in turn can cause the worm gear 32 to rotate, the rotation of worm gear 32 can cause the worm wheel 31 to rotate, and the rotation of worm wheel 31 can cause the rotation shaft 29 to rotate, the rotation of the rotation shaft 29 can cause the cam 30 to rotate, and the rotation of the cam 30 can strike the dust removal screen plate 27 and the filter screen plate 25, cleaning the dust on the surface of the dust removal screen plate 27 and the filter screen plate 25, ensuring the airflow permeability of the dust removal screen plate 27 and the filter screen plate 25, and improving the service life of the dust removal screen plate 27 and the filter screen plate 25, after use, the processing door 37 can be opened to allow the dust to be processed, the mouth 38 can be discharged;

With the rotation operation of cam 30, the dust removal screen plate 27 and the filter screen plate 25 are subjected to force, and the movement of the connecting block 35 in the connecting groove 34, as well as the elastic force reset operation of the connecting spring 36, can cause the dust removal screen plate 27 and the filter screen plate 25 to exhibit reciprocating motion, which can cause the dust removal screen plate 27 and the filter screen plate 25 to exhibit intermittent motion, the shaking of the dust removal screen plate 27 and the filter screen plate 25 can avoid the accumulation of smoke and dust in the fixed position of the processing box 23, so as to prevent the adhesion of smoke and dust in the processing box 23, and facilitate the subsequent cleaning operation of smoke and dust by the staff.

It should be noted that in this article, relational terms such as first and second are only used to distinguish one entity or operation from another, and do not necessarily require or imply any actual relationship or order between these entities or operations, moreover, the terms ‘including’, ‘containing’, or any other variation thereof are intended to encompass non-exclusive inclusion, such that a process, method, item, or device that includes a series of elements includes not only those elements, but also other elements not explicitly listed, or elements inherent to such process, method, item, or device.

Although the embodiments of the present invention have been shown and described, it will be understood by those skilled in the art that various changes, modifications, substitutions, and variations can be made to these embodiments without departing from the principles and spirit of the present invention, the scope of the present invention is limited by the appended claims and their equivalents.

1. A portable handheld welding machine powered by a miniature lithium battery, comprising a housing (1) and a handle (2) integrally formed with the housing (1), wherein the housing (1) is fixed by two half shells through bolts, and one side of the housing (1) is provided with a welding rod (9), characterized in that: a welding mechanism is provided inside the housing (1), a protective mechanism is provided on one side of the housing (1), and a processing mechanism is provided at the tail of the housing (1);
the welding mechanism comprises a battery pack (3), one side of the outer wall of the shell (1) is provided with an installation groove (4), and both sides of the inner wall of the installation groove (4) are provided with grooves (7) in a hemispherical structure, the elastic sheets (5) are fixedly connected to both sides of the battery pack (3), and the elastic sheets (5) form a sliding fit with the inner wall of the installation groove (4), the tail of the elastic sheet (5) is fixedly connected with an integrated protrusion (6), which is in a hemispherical structure, and the protrusion (6) forms a sliding fit with the inner wall of the groove (7), the handle (2) is in sliding fit with the shell (1), a switch (8) is fixedly connected at the connection point, and both the welding rod (9) and the switch (8) are connected to the battery pack (3) through wires, pressing the switch (8) can make the welding rod (9) Power on and perform welding operation, the welding rod (9) is connected to the shell (1) through a fixing component.

2. A portable handheld welding machine powered by a miniature lithium battery according to claim 1, characterized in that: the fixing part comprises a fixing ring (10), one side of the housing (1) is fixed to the fixing ring (10), one side of the outer wall of the fixing ring (10) is provided with a threaded hole (11), and the inner wall of the threaded hole (11) is connected to a threaded rod (12) through threads, one side of the threaded rod (12) is fixedly connected to a rotating block (13), which is far away from the welding rod (9).

3. The portable handheld welding machine powered by miniature lithium batteries according to claim 2, characterized in that the protective mechanism comprises two symmetrically distributed fixed plates (14), which are fixed to the inner wall of the fixed ring (10), one side of the fixed plate (14) is connected to a fixed shaft (15) through a bearing rotation, and one side of the fixed shaft (15) is fixedly connected to a force plate (16), the side of the fixed shaft (15) away from the force plate (16) is fixedly connected to a force plate (17), and one side of the force plate

(17) is fixedly connected to a top block (18), which is in the form of Spherical structure, the top block (18) is in contact with the welding rod (9), and the force plate (17) has a V-shaped structure, through which the welding rod (9) can be locked.

4. The portable handheld welding machine powered by a miniature lithium battery according to claim 3, characterized in that: a pressure plate (19) with a circular arc structure is fixedly connected to one side of the threaded rod (12) away from the rotating block (13), a pressure block is fixedly connected to one side of the pressure plate (19), and a pressure groove is opened on one side of the pressure block, the top and bottom of the pressure plate (19) are both provided with rotating grooves (20), and the inner wall of the rotating groove (20) is rotatably connected to a rotating shaft (21) through a bearing, the rotating shaft (21) forms a rolling fit with the force plate (16).

5. The portable handheld welding machine powered by a miniature lithium battery according to claim 1, characterized in that the processing mechanism comprises a fan (22) located at the tail of the housing (1), and the exhaust end of the fan (22) is fixedly connected to a processing box (23), one side of the outer wall of the processing box (23) is provided with a wind outlet (24), and the outer wall of the processing box (23) on the side away from the wind outlet (24) is provided with a through port (26), the inner wall of the wind outlet (24) covers the exhaust end of the fan (22), and a filter screen plate (25) is provided inside the processing box (23).

6. A portable handheld welding machine powered by a miniature lithium battery according to claim 5, characterized in that: a dust removal mesh plate (27) is provided inside the processing box (23), and a limited position port (28) is opened on one side of the dust removal mesh plate (27), the dust removal mesh plate (27) is located between the filter mesh plate (25) and the wind outlet (24), and an air duct (39) is fixedly connected to the inner wall of the wind outlet (24), the cross-section of the air duct (39) near the wind outlet (24) is trapezoidal, and one end of the air duct (39) near the dust removal mesh plate (27) forms a sliding fit with the inner wall of the limited position port (28).

7. The portable handheld welding machine powered by miniature lithium batteries according to claim 6, characterized in that: the top and bottom inner walls of the processing box (23) are both provided with T-shaped connection grooves (34), and the inner walls of the connection grooves

(34) are slidably connected with T-shaped connection blocks (35), one side of the connection block (35) is fixedly connected with a connection spring (36), which is fixed to one side inner wall of the connection groove (34), and the connection blocks (35) are respectively fixed with the filter screen plate (25) and the dust removal screen plate (27).

8. The portable handheld welding machine powered by miniature lithium batteries according to claim 7, characterized in that the top and bottom inner walls of the processing box (23) are both connected to a rotating shaft (29) through bearings, and the surface of the rotating shaft (29) is fixedly connected to a cam (30), which is in contact with the filter screen plate (25) and the dust removal screen plate (27), respectively.

9. The portable handheld welding machine powered by miniature lithium batteries according to claim 8, characterized in that: the driving shaft of the fan (22) is fixedly connected to a positioning shaft (33), which passes through an air duct (39), one side of the positioning shaft (33) is fixedly connected to a worm (32), and the surface of the rotating shaft (29) is fixedly connected to a worm wheel (31), which meshes with the worm (32).

10. The portable handheld welding machine powered by miniature lithium batteries according to claim 9, characterized in that: one side of the outer wall of the processing box (23) is provided with a processing port (38), and one side of the outer wall of the processing box (23) is hinged with a processing door (37) covering the processing port (38), which is fixed to the processing box (23) by a lock buckle, and the processing door (37) is located between the filter screen plate (25) and the dust removal screen plate (27).

11. The portable handheld welding machine powered by a miniature lithium battery according to claim 1, characterized in that: one side of the welding rod (9) is fixedly connected to a support (40), the support (40) is located inside the fixed ring (10), and the surface of the support (40) is connected to a threaded ring (41) through threads, a gasket (42) is placed on the side of the threaded ring (41) close to the welding rod (9), and a wiring channel (43) is opened on one side of the support (40).
